(19) United States
(12) Patent Application Publication
(10) Pub. No.: US 2012/0253927 A1
(43) Pub. Date: Oct. 4, 2012

(54) MACHINE LEARNING APPROACH FOR DETERMINING QUALITY SCORES

(75) Inventors: Tao Qin, Beijing (CN); Tie-Yan Liu, Beijing (CN); Bin Gao, Beijing (CN); Jingyi Xu, Beijing (CN); Zeyong Xu, Beijing (CN); Wei-Ying Ma, Beijing (CN)

(73) Assignee: Microsoft Corporation, Redmond, WA (US)

(21) Appl. No.: 13/078,598

(22) Filed: Apr. 1, 2011

(51) Int. Cl. G06Q 30/00

(52) U.S. Cl. 705/14.49

(57) ABSTRACT

Some implementations generate a mapping function using one or more historic performance indicators for a set of ad-keyword pairs and one or more advertisement metrics extracted from the set of ad-keyword pairs. The mapping function may be applied to map one or more advertisement metrics of a particular ad-keyword pair to determine a quality score for the particular ad-keyword pair. For example, the quality score may be used when determining whether to select an advertisement for display or may be provided as feedback to an advertiser. Additionally, in some implementations, the mapping function may be applied to determine a quality score for a new ad-keyword pair that has not yet accumulated historic information.

### BACKGROUND

Advertising is typically the primary source of revenue for commercial search sites that provide search services to the public. When a user submits a search query to a commercial search site, an advertising service associated with the search site may decide whether to display one or more advertisements with the search results. Further, if advertisements are to be displayed, the advertising service also determines which ads to display from among available candidate ads, and how to rank or position the ads with the search results.

In some cases the ads are chosen based, at least in part, on an auction bidding process. In the auction bidding process, advertisers bid a certain amount to have their ads displayed with search results in response to queries containing one or more specified keywords. Thus, the amount of the bid may influence whether the ad is displayed and may also influence the rank or position of the ad. Additionally, various methods may be applied for charging the advertisers for the advertising service. For example, the advertisers may be charged based on the number of ad impressions displayed to users, may be charged when a user clicks on an ad displayed with the search results, and the like.

In such an advertising-based revenue model, it is desirable that the advertisements provide information that is useful to the user and relevant to the user's search query. For example, if the advertising service presents ads that a user finds useful, then the user will be more likely to click on the ads displayed, and also more likely to click on ads in the future. This can result in increased revenue for the advertising service, while also fulfilling the expectations of the advertisers. Accordingly, the advertising service may strive to ensure advertisement suitability by gauging the quality of advertisements submitted by advertisers.

To determine advertisement quality, a quality score may be used as a dynamic variable assigned to ads and keywords. The quality score may provide a measure as to how relevant a particular ad is to a particular keyword and/or to a user's search query. Thus, the quality score may influence whether an ad is displayed with search results, and the rank or position of the ad in the search results. Quality score may also be applied, at least in part, when determining the minimum value of bids accepted for particular keywords. For instance, the higher the quality score, the better the ad position and the lower the amount of the minimum accepted bid for a particular keyword. Consequently, being able to accurately estimate the quality score of an ad-keyword pair can provide benefits to the advertising service, the advertisers and the users of a search site.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide techniques for estimating quality scores for advertisements. For example, implementations herein enable use of a number of different indicators or metrics when estimating the quality score. Some implementations include a machine learning approach that enables automatic and dynamic estimation of quality scores, and updating of quality scores as relevant information changes. Additionally, some implementations enable estimation of a quality score for a newly submitted advertisement.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example framework for quality score estimation according to some implementations.

FIG. 2 is a flow diagram of an example process for quality score estimation according to some implementations.

FIG. 3 is an example of a search results page including advertisements ranked based, at least in part, on estimated quality scores according to some implementations.

FIG. 4 illustrates an example structure of an advertiser ad group having advertisements and keywords according to some implementations.

FIG. 5 is a block diagram of an example system architecture for a search service including quality score estimation according to some implementations.

FIG. 6 is a block diagram illustrating multifunction quality score estimation according to some implementations.

FIG. 7 is a flow diagram of an example process for quality score estimation according to some implementations.

FIG. 8 is a flow diagram of an example process for providing feedback to advertisers according to some implementations.

FIG. 9 is a block diagram of an example computing device according to some implementations.

### DETAILED DESCRIPTION

### Quality Score Estimation

The technologies described herein generally relate to estimating a quality score for an advertisement. For example, the quality score may be estimated for an advertisement paired with a keyword (i.e., an ad-keyword pair) for use in an advertising service. Further, some implementations provide for a machine-learning-based multi-stage approach for quality score estimation. For example, historic advertisement data for a set of ad-keyword pairs, such as from one or more logs of the advertising service, may be used for training a first function used in a first stage and a second function used in a second stage of the multi-stage approach. In some implementations, the first stage may be a performance-based stage, in which an aggregation function is trained and used to determine aggregated performance indicators for the set of ad-keyword pairs by aggregating multiple performance metrics, referred to hereafter as performance indicators (PIs). In this stage, the PIs may be obtained from the historical ad data that has been recorded for the set of ad-keyword pairs. Examples of PIs that may be obtained include a number of impressions, a number of clicks, a measured click-through rate, a cost per click, and a total cost. The number of impressions is the number of times that an ad is displayed to users, such as in a search results pages. The number of clicks is the number of times that users click on the displayed ad. The measured click-through rate is the number of times the ad is actually clicked on in comparison with the number of impressions of the ad that have been presented. The cost per click is the amount that the advertiser pays each time the ad is clicked on by a user. The total cost is the total amount that the advertiser pays for the ad (e.g., cost per impression plus cost per click, if applicable). In some implementations, the obtained PIs may be aggregated using a first function, and the aggregated PIs may be considered as an intermediate quality score.

As used herein the term “ad-keyword pair” may refer to a single advertisement or may refer to a group of advertisements (i.e., an ad group) that is paired with a bid keyword. For example, an ad group may include a plurality of ads and a plurality of different keywords. Thus, depending on a desired implementation, quality scores may be determined for individual ads, for ad groups, or for both.

According to some implementations, the second stage of the multistage approach may be an advertisement-metrics-based stage, in which a mapping function is trained or learned, based in part on the corresponding aggregated PIs from the first stage, and by mapping multiple advertisement metrics of the advertisements in the set of ad-keyword pairs. Examples of advertisement metrics include a landing page relevance, a landing page quality, an ad copy relevance, an ad copy quality, a length of the ad copy, and the like. The landing page relevance is the relevance of the webpage that a user is directed to when the user clicks on an ad. For example, the landing page should be directly related to the ad and the searched keyword contained in the user's search query. The relevant content should also appear on the first page of the landing page and display the user's searched keywords in text format. Landing page quality refers to the quality of the webpage that the user is directed to when the user clicks on an ad. For example, the landing page should adhere to certain editorial guidelines, be well organized, and make it easy for the user to purchase a product, sign up for a service, create an account, or the like. Further, the landing page should not contain a large amount of unrelated advertising, contain misleading offers, spyware, or have functionality problems. Ad copy relevance refers to the relevance of the ad copy to the user's searched keywords. The ad copy is one or two lines of text that, along with a hyperlink to the landing page, are typically presented as the advertisement with the search results. Accordingly, relevant ad copy should contain one or more of the user's searched keywords. Ad copy quality refers to the structure and content of the ad copy. For example, it is desirable for the ad copy to include good grammatical structure, dynamic text, unique selling points, be focused toward an identified potential customer, and motivate the user to click on the ad. Length of the ad copy refers to how many words are contained in the ad copy, as too long an ad copy may not be read by a user, while too short an ad copy may not convey sufficient information.

Accordingly, training of the mapping function in the mapping stage may take into consideration these and other ad metrics in combination with the aggregated performance indicators determined in the performance-based stage. Following training of the mapping function, the trained mapping function may then be used to generate a quality score for a particular ad-keyword pair. For example, the trained mapping function may be used to map ad metrics of the particular ad-keyword pair for determining a quality score for the particular ad-keyword pair. Quality scores thus determined for a plurality of ad-keyword pairs may be used by the advertising service when determining when and where to use ads, how to rank ads, and the like. The quality scores may further be used to determine an amount of a minimum bid that will be accepted from an advertiser for particular ad-keyword pairs.

The advertising service may provide the quality score for a particular ad-keyword pair as feedback to the advertiser to enable the advertiser to improve the ad, and thereby improve the ad ranking and placement. Thus, some implementations herein enable estimation of a quality score to provide advertisers with information on the quality of their ad-keyword pairs so that the advertisers will have reasonable expectations for their ads. Based on the feedback, the advertisers can strive to improve their ads or the pairing of their ads with particular keywords. By improving the quality scores of their ads, advertisers may improve the rankings and effectiveness of their ads, since users are more likely to click on ads of higher quality. Further, because payment by the advertisers to the advertising service may be based, at least in part, on whether users actually click on the ads, having ads of higher quality can also increase the revenue of the advertising service. Additionally, some implementations herein enable estimation of a quality score for a newly submitted ad-keyword pair before the ad is used by the ad service. Thus, an advertiser may be able to improve the ad or the ad-keyword pairing even before the ad is placed online.

Further, because implementations herein adopt a machine learning based approach, the functions for quality score estimation may be automatically learned and updated without human involvement. Additionally, the machine learning approach is able to leverage as many metrics, features, signals or performance indicators as are available when determining the quality score, which can lead to greater accuracy in quality score estimation. Also, because the quality score estimation herein utilizes a learned mapping function based on advertisement metrics, this mapping function can also be applied when determining an estimated quality score for new ad-keyword pairs for which no empirical or historical performance data has yet been collected.

### Example Framework

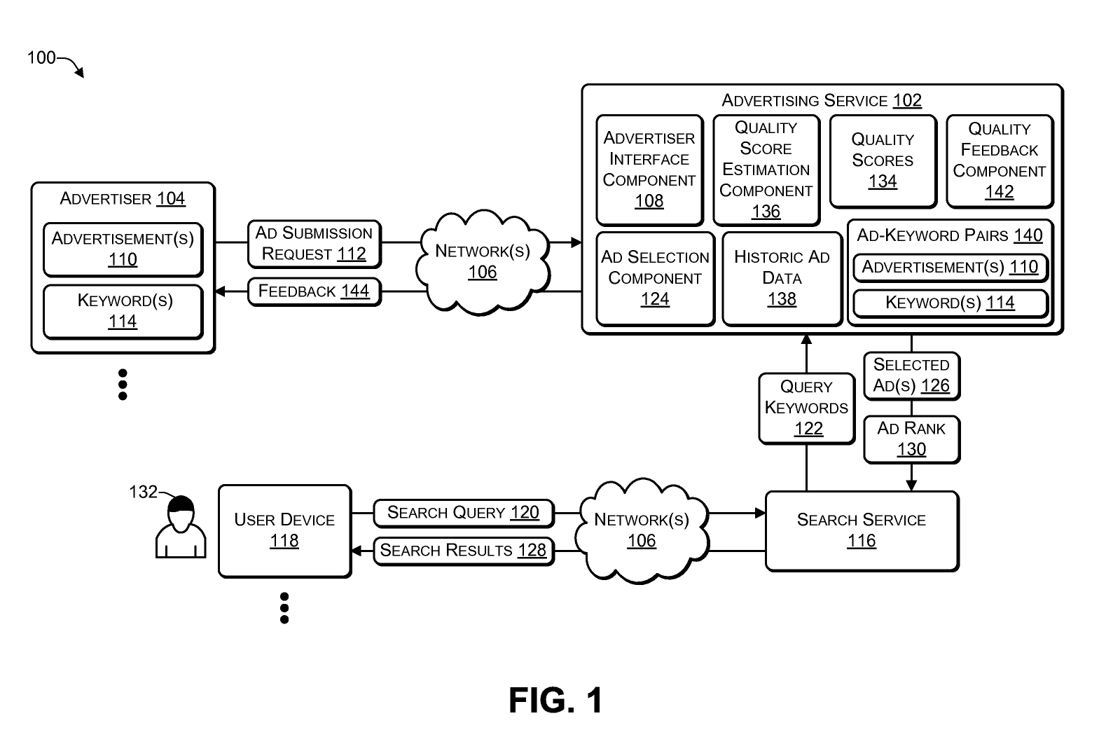

FIG. 1 illustrates an example framework 100 for quality score estimation of advertisements according to some implementations. In the illustrated example, an advertising service 102 is in communication with one or more advertisers 104 through one or more network(s) 106. Network(s) 106 may include the Internet, a local area network (LAN), a wide area network (WAN), a wireless network, or other suitable communication network, or a combination of networks, enabling communication between advertising service 102 and advertiser 104. Thus, advertisers 104 may conduct business with and manage their advertisements with advertising service 102 through network(s) 106 or through other suitable communication functionalities.

Advertising service 102 may include an advertiser interface component 108 that enables advertiser 104 to access and utilize advertising service 102. Advertiser interface component 108 may be a series of webpages, or the like, that present a graphic user interface to advertiser 104 to enable advertiser 104 to submit one or more advertisements 110 to advertising service 102. For example, advertiser 104 may submit an advertisement 110 in an ad submission request 112 transmitted to advertising service 102 over network(s) 106. In some implementations, advertiser 104 may use the advertiser interface component 108 to create the advertisement 110, while in other implementations, the advertiser 104 may create the advertisement 110 independently and submit the advertisement 110 to the advertiser interface component 108 with the ad submission request 112.

The ad submission request 112 may further identify one or more keywords 114 that the advertiser 104 would like the advertisement 110 to be displayed in connection with. Additionally, in implementations in which the advertising service 102 uses an auction-type revenue model, the ad submission request 112 may also include a bid amount that the advertiser 104 is willing to pay the advertising service 102 for displaying the advertisement 110 in connection with the keyword 114. For example, the advertiser may pay an amount for each impression of the ad presented to a user (pay-per-impression), may pay for each click on the ad by a user (pay-per-click), or combinations thereof. Other payment models may also be used, such as pay-per-sale, pay-per-page-visit, pay-per-lead (e.g., filling out a form at the advertiser's website), or the like.

In the example illustrated, advertising service 102 may be associated with a search service 116. However, other implementations of advertising service 102 contemplated herein are not limited to use with a search service. One or more user devices 118 may be in communication with search service 116 through network(s) 106, which may include the same network type as that used for communication between advertiser 104 and advertising service 102, or a different network type. For example, the user device 118 may submit a search query 120 to search service 116 over network(s) 106. When the search service 116 receives the search query 120, the search service 116 may provide one or more query keywords 122 from the search query 120 to the advertising service 102. In response, an ad selection component 124 of the advertising service 102 may identify one or more selected ads 126 to be displayed with search results 128 that will be provided in response to the search query 120. The advertising service 102 may also include position or ranking information as ad rank 130 when there are multiple selected ads 126. The search service 116 may then assemble the search results with the selected ads 126, such as in the form of a webpage, to provide search results 128 to the user device 118. The search results 128 may include the one or more selected ads 126 placed in the search results 128 in accordance with the ad rank 130 provided by the advertising service 102.

The user device 118 receives and displays the search results 128 to a user 132. In the case of a pay-per-impression agreement between the advertiser and the advertising service 102, the impression of a selected ad 126 to the user 132 can be recorded and the advertiser 104 charged accordingly. Further, the user 132 may choose whether or not to click on or otherwise select one of the selected ads 126 included in the search results 128. If the user 132 does click on a selected ad 126, this action can be detected by the search service 116. In the case of a pay-per-click agreement between the advertiser 104 and the advertising service 102, the click event can be recorded and the advertiser 104 charged accordingly.

When determining whether any ads 110 should be selected as selected ads 126, which ads 110 to select, and the ad rank 130 identifying a ranking or position of the selected ads 126, ad selection component 124 may employ quality scores 134, as determined by a quality score estimation component 136. The quality score estimation component 136 may be configured to use historic ad data 138 to train a mapping function that is employed to determine quality scores 134 based on a number of different metrics, features and indicators (e.g., advertisement attributes, landing page attributes, etc.) determined for each advertisement-keyword pair 140. The quality score estimation component 136 may automatically and dynamically apply different weights to the various performance indicators and advertisement metrics based on machine learning, as described additionally below. Since the advertising service 102 is a dynamic system and because the quality score estimation component 136 herein is able to dynamically change and update the mapping function as the advertising service 102 (and the search service 116) evolve, the quality scores 134 can be kept current and accurate, such as by using the quality score estimation component 136 to periodically update the quality scores 134.

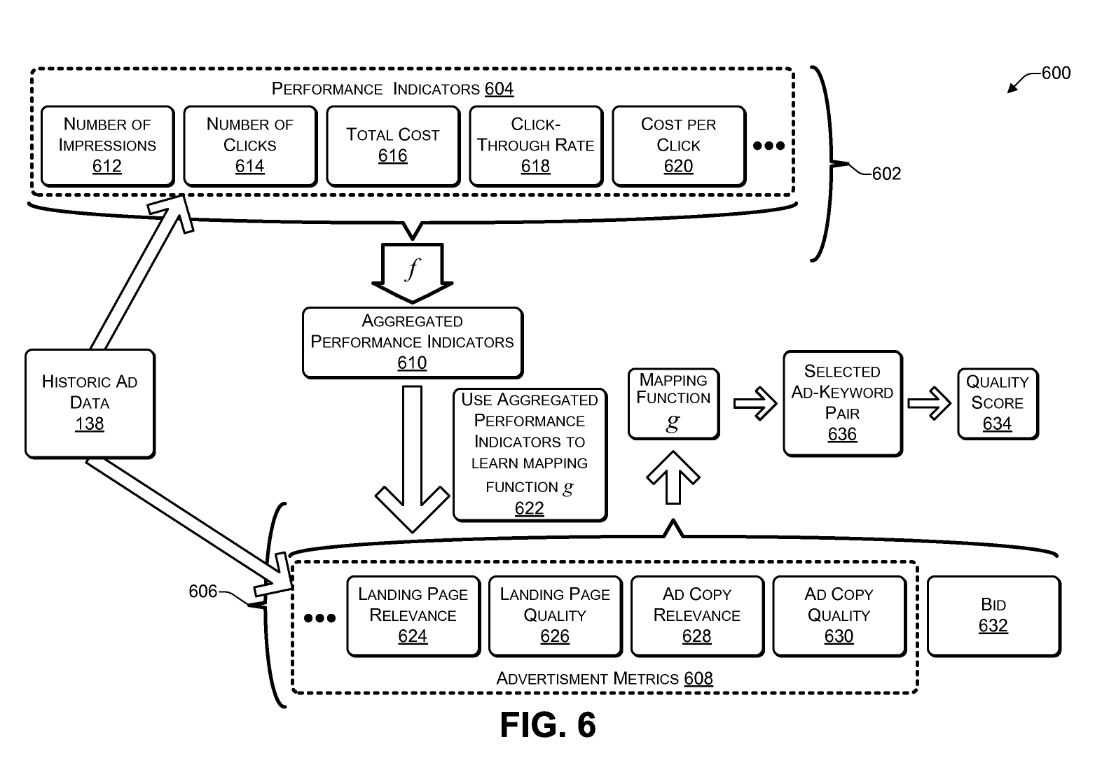

In some implementations, the quality score estimation component 136 adopts a machine-learning approach to quality score estimation that may include two parts or stages. In a performance-based stage, an aggregation function is learned using historic ad data 138 to obtain aggregated PIs, which may also be referred to as intermediate quality scores. As mentioned above, the historic ad data 138 may include historical performance information recorded for a set of ad-keyword pairs, such as number of impressions, number of clicks, total cost, measured click-through rate, and cost per click. In an ad-metrics-based stage, a mapping function is learned, which maps a plurality of advertisement metrics or features of the ad-keyword pairs from the historic ad data 138 while taking into consideration the corresponding aggregated PIs to generate a trained mapping function that can be subsequently used to determine quality scores for the ad-keyword pairs 140. As mentioned above, during the training and subsequent quality score determination, implementations herein may leverage a number of different metrics from an advertisement, such as landing page relevance, landing page quality, ad copy relevance, ad copy quality, length of ad copy, and the like. Furthermore, because the machine learning approach herein takes into consideration factors other than just historical performance, some implementations are able to estimate a quality score for new ads or new keywords for which no historical data has yet been collected. Additional details of the quality score estimation techniques herein are discussed below with reference to FIG. 6.

In some implementations, advertising service 102 may include a quality feedback component 142 to provide feedback 144 to an advertiser 104 regarding the quality scores 134 estimated for the advertiser's advertisements 110. For example, when the quality score 134 for an advertisement 110 has been estimated by the quality score estimation component 136, the quality feedback component 142 may provide the estimated quality score 134 to the advertiser 104, and may also provide suggestions for improving the quality score, or reasons why the quality score may be lower than advertiser's expectations. For example, the quality feedback component 142 may suggest that the advertiser 104 improve one or more of ad copy relevance, ad copy quality, landing page quality, landing page relevance, ad copy link, or other advertisement metrics.

### Example Process

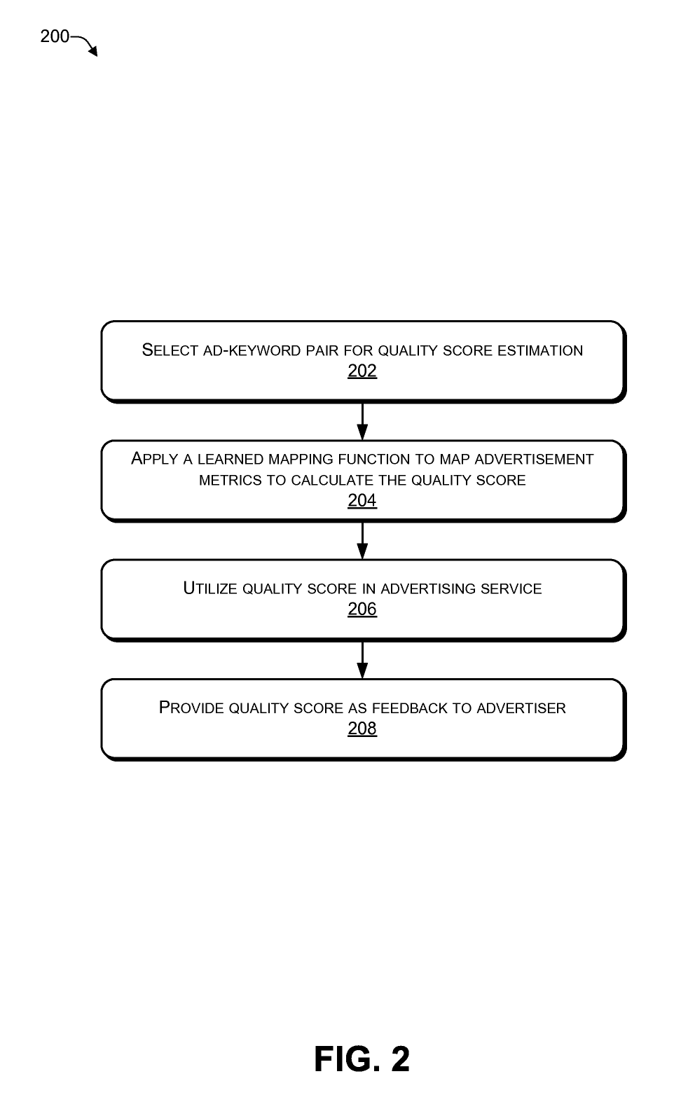

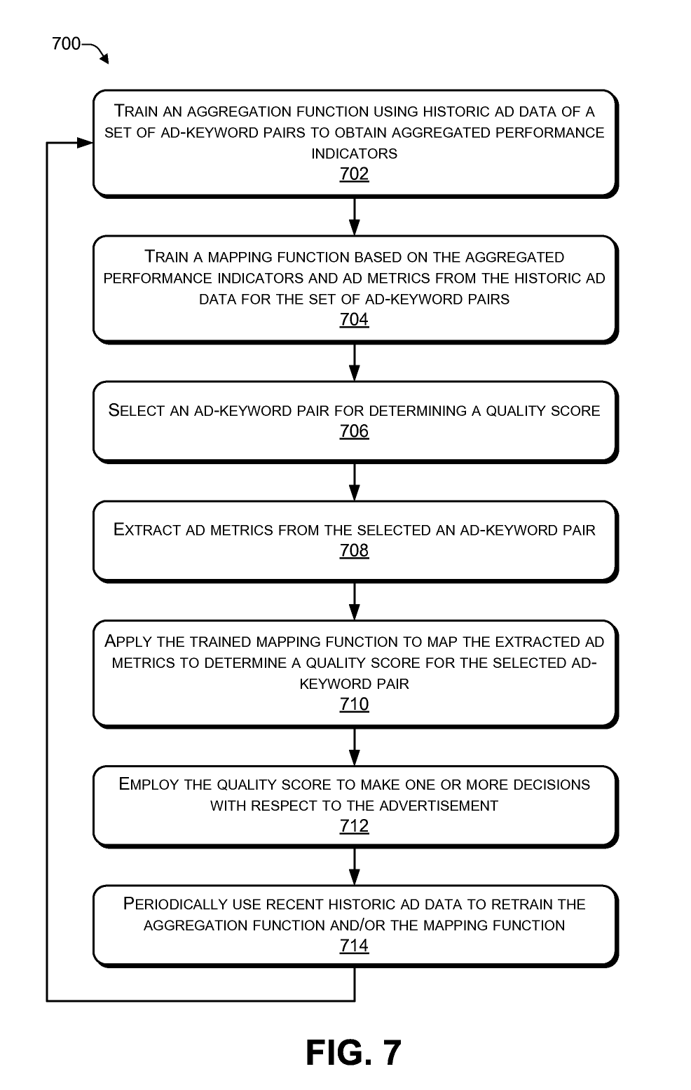

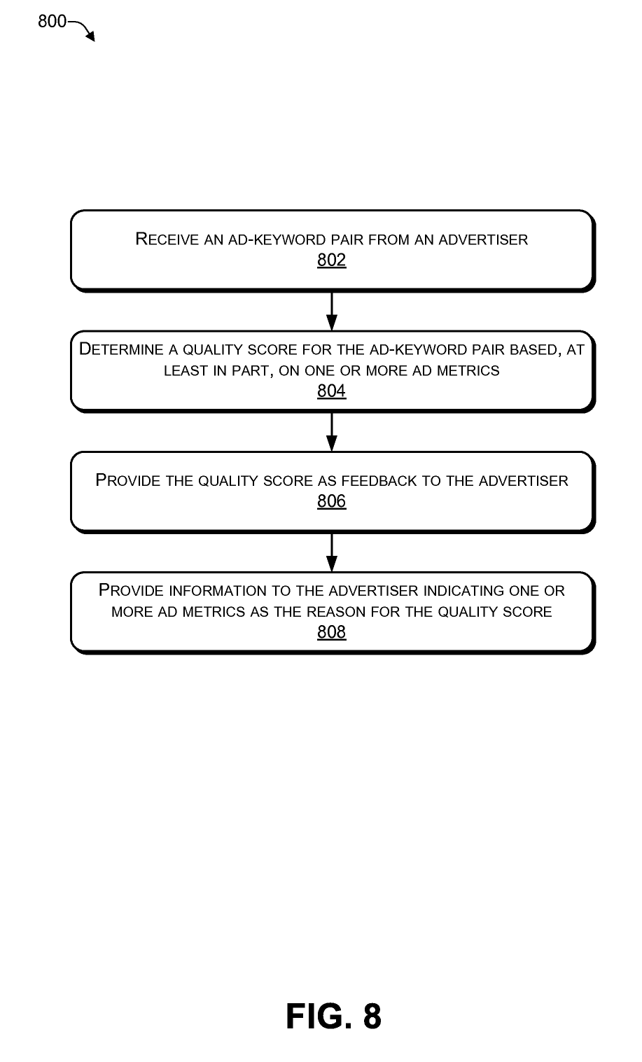

FIG. 2 is a flow diagram of an example process 200 for quality score estimation according to some implementations herein. In the flow diagram of FIG. 2, as well as in the flow diagrams of FIGS. 7 and 8, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include modules, programs, objects, components, data structures, and the like that perform particular functions or implement particular abstract data types. The order in which the blocks are described is not intended to be construed as a limitation, and any number of the described operations can be combined in any order and/or in parallel to implement the process. For discussion purposes, the process 200 is described with reference to the framework 100 of FIG. 1, although other frameworks, architectures, systems and environments may implement this process.

At block 202, the quality score estimation component 136 selects an ad-keyword pair for determining a quality score. For example, the ad-keyword pair may have been in use by the advertising service for some period of time, or may be a newly submitted ad-keyword pair that has not yet been put into use.

At block 204, the quality score estimation component 136 applies a mapping function to map ad metrics of the selected ad-keyword pair to calculate the quality score. For example, the quality score estimation component may examine the ad metrics for the selected ad-keyword pair and apply the ad metrics to the trained mapping function to determine an estimated quality score. The mapping function may be trained from historical advertisement data from a plurality of ad-keyword pairs, such as may be obtained from the logs of an advertising service. As discussed additionally below, the training of the mapping function may be learned in two stages. A first stage may take into consideration performance indicators of the historic ad data, while a second stage takes into consideration ad metrics of the ad-keyword pairs in the historic ad data. Accordingly, after the mapping function has been trained, then even in implementations in which the selected ad-keyword pair does not have any historic performance information recorded, the mapping function may still be applied to determine the quality score based on the ad metrics for the selected ad-keyword pair.

At block 206, the advertising service 102 utilizes the quality score in the advertisement service. For example, the ad service may apply the quality score during selection of advertisements, such as for use by a search service when providing search results in response to a search query. Additionally, the ad service may apply the quality score when determining minimum acceptable bids for the ad, the ad group or the advertiser.

At block 208, optionally, the advertising service 102 may provide the estimated quality score for the ad-keyword pair to the advertiser 104 as feedback. For example, the advertising service may provide the quality score, and may also provide additional information, such as suggestions for improving the quality score and/or reasons that the quality score was estimated to be a particular value.

### Example Search Results Page with Ads Ranked by Quality Score

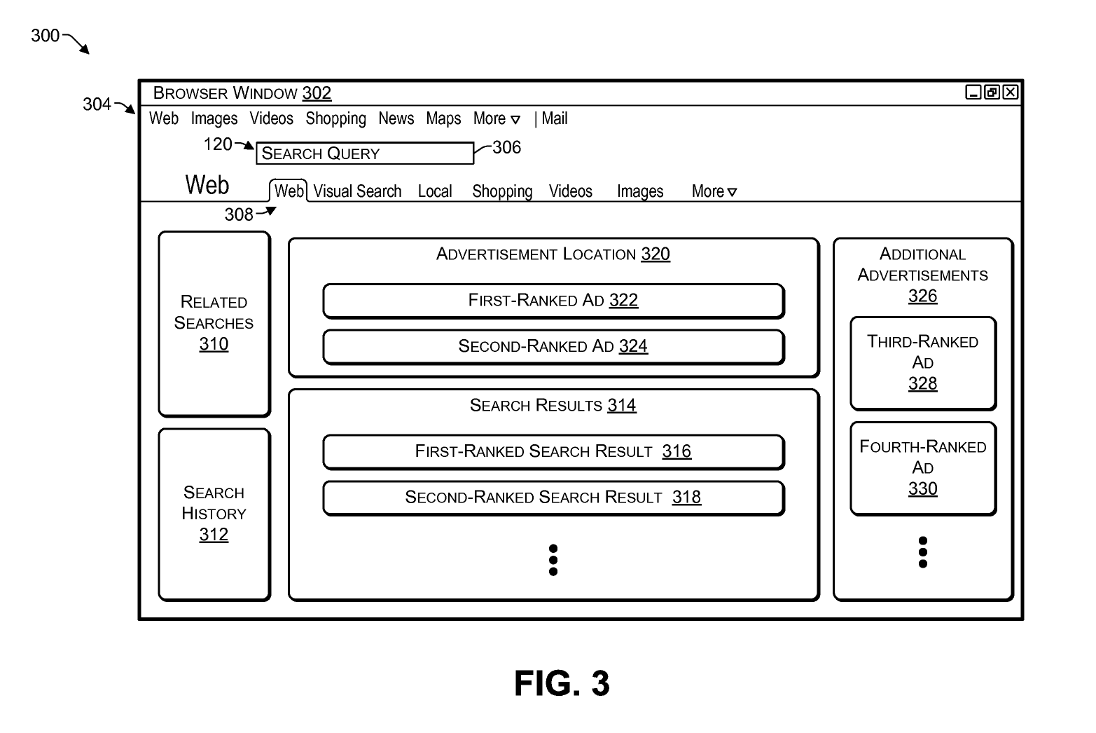

FIG. 3 illustrates an example search results page 300 that the user 132 may receive from search service 116 as search results 128 in response to the search query 120 according to some implementations herein. For example, as mentioned above, when the user 132 issues the search query 120 to the search service 116, the ad selection component 124 decides whether to display some ads 110, which ads 110 to display, and how to rank the ads 110 when more than one ad 110 is selected to be displayed. One or more selected ads 126 may be included in the search results 128, positioned according the ad rank 130 determined by ad selection component 124.

In the illustrated example, search results page 300 may be displayed in a browser window 302, and may include a search menu 304 for selecting a resource to be searched, such as the “Web,” “images,” “videos,” “shopping,” “news,” “maps,” or “more,” along with an option to access email. Search results page 300 may further include a query entry window 306 for receiving the search query 120, and a results source menu 308 indicating a source of the results, e.g., the “Web,” “visual search,” “local,” “shopping,” “videos,” “images,” and “more.” Search results page 300 may further include a listing of related searches 310 and/or a search history 312. The search results page 300 may further include a presentation of search results 314 determined by the search service 116 to be relevant to the search query 120, such as a first-ranked search result 316, a second-ranked search result 318, and so forth.

According to some implementations herein, the search results page 300 may include one or more advertisements positioned or ranked based, at least in part, on a quality score 134 determined by the quality score estimation component 136. In the illustrated example, an advertisement location 320 may immediately precede the search results 314, and may include one or more advertisements, such as a first-ranked ad 322 and a second-ranked ad 324. A location for additional advertisements 324 may be positioned to one side of search results 314, and may include a third-ranked ad 328, a fourth-ranked ad 330, and so forth. According to one possible method for determining ad rank 130, the ad rank 130 may be equal to the bid amount multiplied by the quality score. Thus as an example, when ad rank 130 is determined according to this method, if the bid amount for ads 322, 324, 328 and 330 was the same amount, then the rank of ads 322, 324, 328 and 330 would correspond to the quality score 134 for each ad. Thus, in this example, first-ranked ad 322 may have a higher quality score 134 than second-ranked ad 324, second-ranked ad 324 may have a higher quality score 134 than third-ranked ad 328, and so on.

When the user 132 clicks on one of the ads 322, 324, 328 or 330, the user's browser window 302 may be redirected to a landing page (not shown in FIG. 3) associated with the clicked-on ad. For example, the landing page may be a webpage that contains more information about the advertised product or service, provides an opportunity to purchase or sign up for the advertised product or service, and the like). Also, in some revenue models, the advertiser 104 who owns the clicked-on ad may be charged for the click or other actions made by the user 132 at the landing page. Further, while FIG. 3 illustrates one example configuration for a search results page, numerous other configurations and arrangements are possible, and implementations herein are not limited to any particular configuration.

### Example Advertisement Organization

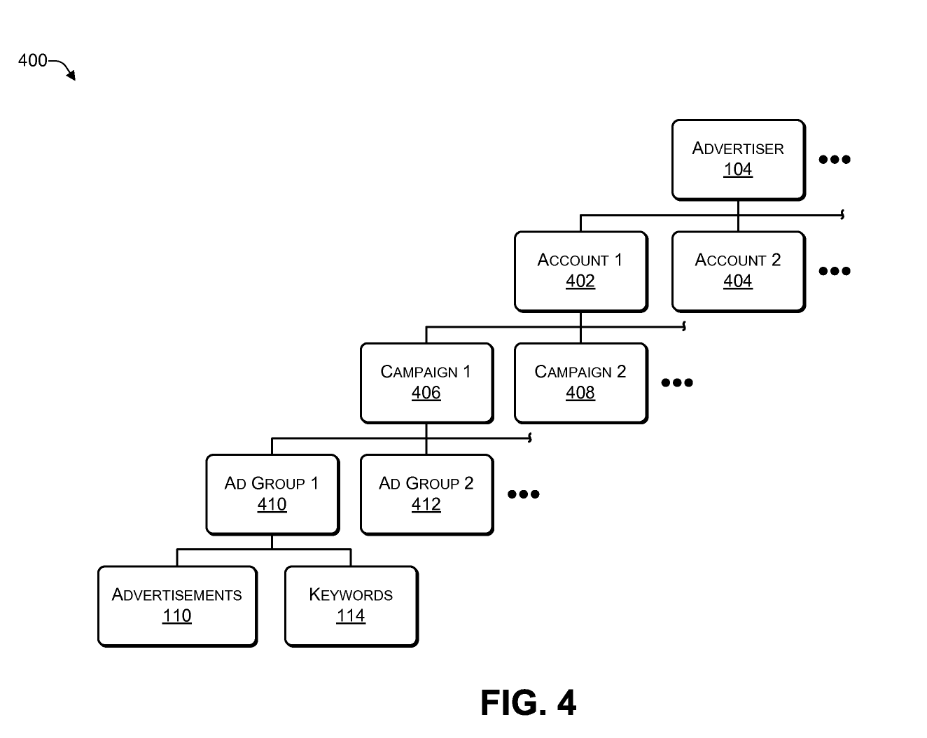

FIG. 4 illustrates an example structure 400 of how advertisements might be organized by an advertiser 104 for use with an advertising service, such as advertising service 102, according to some implementations herein. Advertiser 104 may have one or more accounts with ad service 102, such as account one 402, account two 404, and so forth. Each account may include one or more campaigns, such as campaign one 406, campaign two 408, and so on. For example, each campaign might relate to a different product or service of the advertiser 104. Each campaign may include one or more ad groups, such as ad group one 410, ad group two 412, etc. The advertisements 110 and keywords 114 may thus be organized into a particular ad group, such as ad group one 410 in the illustrated example. In each ad group 410, 412 there may be multiple ads 110 and multiple keywords 114. For example advertiser 104 may desire to associate each ad 110 with a number of different keywords 114 related to the product or service being advertised. Further, different ad copy may be used for different keywords in an ad group 410, 412 so that the ads 110 appear relevant to particular keywords 114 corresponding to query keywords 122 submitted in user search requests, and are thus more likely to be clicked on by a user. A quality score 134 may be computed for each ad-keyword pair in an ad group. The quality score 134 may then be used in any of several different ways, such as influencing the actual cost-per-click (CPC) for keywords (i.e., the minimum acceptable bid). The quality score 134 may also be used for determining whether an ad bid on a keyword is eligible to enter an ad auction. The quality score 134 may also be used when determining the rank or position in which an ad will be ranked in search results. In general, ads having a higher quality score 134, incur a lower cost and achieve a better ad rank.

### Example System Architecture

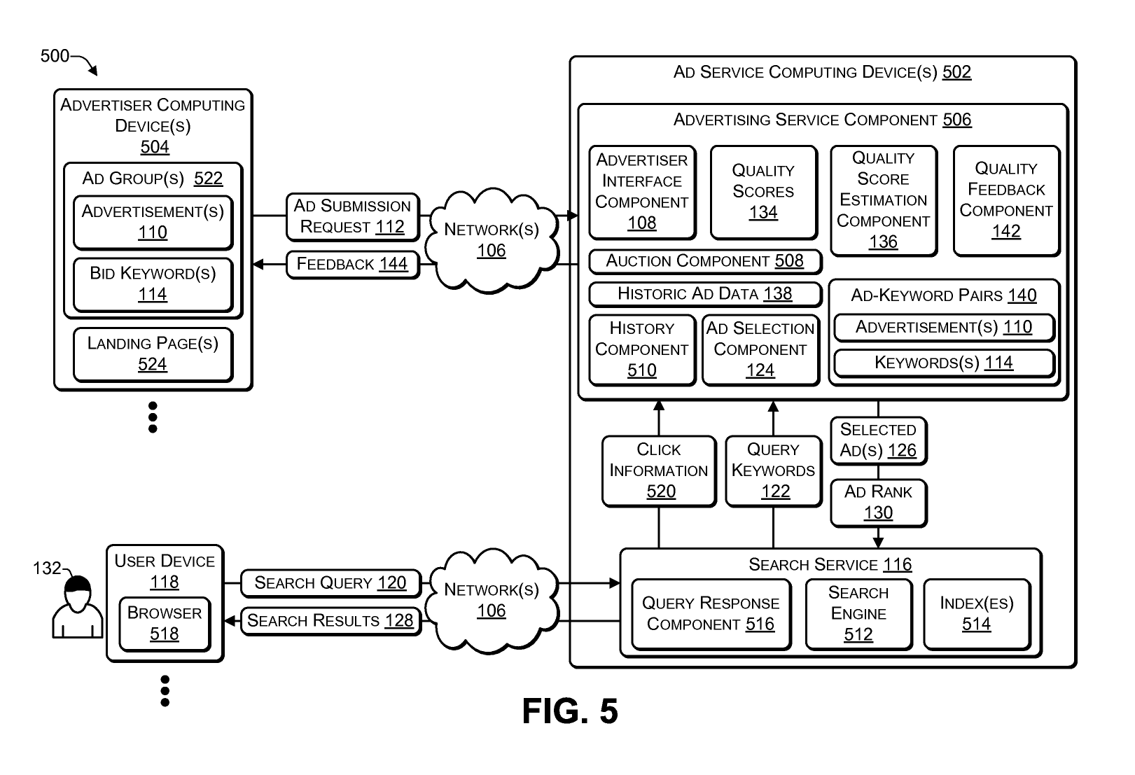

FIG. 5 is a block diagram of an example system architecture 500 for providing an advertising service including quality score estimation according to some implementations herein. The system architecture 500 may incorporate, at least in part, the framework 100 of FIG. 1. In the illustrated system architecture 500, one or more ad service computing devices 502 are in communication with one or more advertiser computing devices 504 through network(s) 106. Advertising computing device 502 includes an advertising service component 506 that may include advertiser interface component 108, ad selection component 124, quality scores 134, quality score estimation component 136, historic ad data 138, ad keyword pairs 140, and quality feedback component 142. As described above, quality score estimation component 136 may determine quality scores 134 for ad-keyword pairs 140 using a multistage machine learning approach, as discussed additionally below with reference to FIG. 6.

Advertising service component 506 may further include an auction component 508 and a history component 510. Auction component 508 may manage the auction portion of the advertising service. For example, the auction component may set minimum bids for particular ad-keyword pairs 140, may receive and manage the bids from advertisers, perform billing functions, and the like. History component 510 may maintain a log or history of historic ad data 138 for each ad-keyword pair 140 or other ad-keyword pairs used in the past. For example, history component 510 may track the number of impressions, the number of clicks, and other aspects and actions recorded with respect to each ad-keyword pair 140. The history component 510 may provide the historic ad data 138 for each ad-keyword pair 140 to quality score estimation component 136 for use in determining quality scores 134, and may further provide historic ad data 138 to auction component 508 for billing purposes, minimum bid determination, and the like.

Search service 116 may run on the same computing device(s) 502 as advertising service component 506, or on separate computing devices dedicated to the search service 116. Search service 116 may include a search engine 512, one or more search indexes 514 and a query response component 516. When the search query 120 is received by a search service 116, query response component 516 provides query keywords 122 from the search query 120 to the ad selection component 124 and receives back the selected ads 126 and the corresponding ad rank 130. Query response component 516 may then assemble the search results 128 in a search results page as described above with reference to FIG. 3, including the selected ads 126 assembled according to the ad rank 130. A browser 518 at user device 118 may display the search results 128 to the user 132. Furthermore, the query response component 516 may track whether the user 132 clicks on any of the ads in the search results 128, and may provide click information 520 to the history component 510 to enable the history component 510 to keep track of clicks or other user actions taken for each ad-keyword pair 140.

Advertiser computing device 504 may include one or more ad groups 522, as described above with reference to FIG. 4, each of which may include advertisements 110 and keywords 114. Advertiser computing device 504 may further include one or more landing pages 524. For example, in some implementations, the landing pages 524 may be maintained in a website hosted on advertiser computing devices 504. However, in other implementations, landing pages 524 may be maintained in one or more websites hosted on other web hosting computing devices (not shown) on behalf of advertisers 104. Furthermore, while FIG. 5 illustrates one possible suitable system architecture 500 according to some implementations, numerous variations will be apparent to those of skill in the art in view of the disclosure herein.

### Example Multistage Quality Score Estimation

FIG. 6 is a block diagram illustrating an example of a multistage approach 600 to quality score estimation according to some implementations herein. For example, the multistage approach 600 may be implemented by the quality score estimation component 136 described above with reference to FIGS. 1 and 5. As mentioned above, the quality score estimation herein may include a historic performance-based learning stage 602 in which one or more historic performance indicators (PIs) 604 are considered. The quality score estimation may also include an advertisement-metric-based learning stage 606 in which one or more ad metrics 608 are considered. The result of the multiple stage machine learning is a mapping function that can be used to determine a quality score for a particular ad-keyword pair based on various ad metrics determined for the particular ad-keyword pair.

In the historic performance-based learning stage 602, one or more PIs 604 are extracted from a set of training data, such as historic ad data 138 for a set of ad-keyword pairs that have been used by the advertising service. Based on the PIs 604, an aggregation function ƒ may be learned by maximizing a Kendall's tau correlation between the output of ƒ i.e., the aggregated PIs 610, and all the PIs 604 from the historic ad data 138. As illustrated in FIG. 6, PIs 604 taken into consideration may include a number of impressions 612, a number of clicks 614, a total cost 616, a click-through rate 618, and a cost per click 620, although other historic PIs may also be used in addition to or in place of those illustrated in this example.

Kendall's tau is a measure of correlation that considers the strength of a relationship between two variables. In implementations herein, Kendall's tau correlation is applied between more than two variables for determining the correlation between the aggregation function ƒ and multiple PIs 604. In the example set forth below, each ad-keyword pair 140 may be expressed as the pair (q,i), where q represents the keyword and i represents the advertisement. Accordingly, let xᵢ^{q} indicate the PIs of a keyword-ad pair (q,i). For example, if there are five PIs (e.g., #imp 612, #click 614, total cost 616, CTR 618, and CPC 620), then xᵢ^{q} is a 5-dimensional vector. Based on this, x_{i,k}^{q} can be used to determine the k-th PI of xᵢ^{q}. Then, it is possible to determine a linear aggregation function ƒ such that

ƒ(xᵢ^{q})=ω^{T}xᵢ^{q} .EQ (1)

By maximizing the correlation between the output of ƒ and all the PIs, then:

$${ω}^{*} = {arg}_{ω} max {\sum }_{k} {\sum }_{q} \frac{{\sum }_{i} {\sum }_{j} I \{ ( f ( {x}_{i}^{q} ) - f ( {x}_{j}^{q} ) ) ( {x}_{i , k}^{q} - {x}_{j , k}^{q} ) > 0 \}}{{\sum }_{i} {\sum }_{j} I \{ ( f ( {x}_{i}^{q} ) - f ( {x}_{j}^{q} ) ) ( {x}_{i , k}^{q} - {x}_{j , k}^{q} ) \neq 0 \}} \qquad EQ ( 2 )$$

In which ω* represents the Kendall's tau correlation to serve as an aggregation parameter and I{y} is an indicator function:

$$I \{ y \} = \{ \begin{matrix}1 , & if y is true , \\ 0 , & if y is false .\end{matrix}$$

### Training the Aggregation Function

The aggregation function ƒ may be trained using a set of training data taken from historical ad data 138 collected for a plurality of ad-keyword pairs, such as may be provided by history component 510. The training of the aggregation function ƒ may incorporate a series of operations including: performing feature normalization; counting the pair number of each query; initializing the aggregation parameter; and updating the aggregation parameter. Each of these operations is described additionally below.

### Feature Normalization

Feature normalization may be performed to prevent certain PIs 604 from overpowering other PIs 604 in the quality score estimation. Some implementations herein determine the maximal value of each PI and normalize the PI vectors. Two non-limiting examples of suitable normalization transforms are set forth below. For example, suppose the maximum of the k-th PI is mₖ. Then normalization may be conducted using a normalization transform as follows:

$${x}_{i , k}^{q} = \frac{{x}_{i , k}^{q}}{{m}_{k}} , ∀ q , i , k \qquad EQ ( 3 )$$

Alternatively, some implementations herein may use a log normalization transform, as follows:

x_{i,k}^{q}=ln(x_{i,k}^{q}+1),∀q,i,k EQ (4)

Either of these, or other normalization transforms, may be used to achieve a suitable outcome according to the implementations herein.

### Counting Pair Number of Each Query

Following normalization of the training may further include counting the pair number of each query, such as according to the following equation:

pₖ^{q}=ΣᵢΣⱼI{x_{i,k}^{q}−x_{j,k}^{q}≠0} EQ (5)

The results of this operation are used for updating the aggregation parameter, as described additionally below.

### Initializing the Parameter

Additionally, the aggregation parameter ω may be initialized as follows:

$${ω}_{k} = \frac{1}{k} \qquad EQ ( 6 )$$

### Updating the Parameter

Following the initializing, the aggregation parameter ω may be updated based on the instructions set forth in the following pseudocode.

| For t = 1, 2, . . . | | | | | |
|---|---|---|---|---|---|
| | For q = 1, 2, . . . | | | | |
| | | For i = 1, 2, . . . | | | |
| | | | For j = i + 1, i + 2, . . . | | |
| | | | | For k = 1, 2, . . . | |
| | | | | | If (f(xᵢ^{q}) − f(xᵢ^{q}))(x_{i,k}^{q} − x_{j,k}^{q}) < 0 |
| | | | | | $ω = ω + \frac{η}{{p}_{k}^{q}} \times ( {x}_{i , k}^{q} - {x}_{j , k}^{q } ) \times ( {x}_{i}^{q} - {x}_{j}^{q} )$ |

End for

End for

End for

End for

End for

Here η is a hyper parameter to control the learning rate. Typically, this parameter η may be set to some small value such as 0.001.

### Performing Aggregation of Historic Performance Indicators

Following training, the learned aggregation function ƒ may be used to determine aggregated performance indicators 610 for the set of ad-keyword pairs in the historic ad data 138. In some implementations, the aggregated performance indicators may be referred to as intermediate quality scores. For example, given the PI vector xᵢ^{q} of an ad-keyword pair from the historic ad data 138, the learned aggregation parameter ω can be used to compute the aggregated performance indicator 610. For example, if the normalization transform of EQ (3) was used during training, then the aggregated performance indicator 610 may be determined by applying the learned aggregation function ƒ as follows:

$$f ( {x}_{i}^{q} ) = {\sum }_{k} \frac{{ω}_{k} {x}_{i , k}^{q}}{{m}_{k}} \qquad EQ ( 7 )$$

On the other hand, if the normalization transform of EQ (4) was used during training, then the aggregated performance indicator 610 may be determined by applying the learned aggregation function ƒ as follows:

ƒ(xᵢ^{q})=Σₖωₖ ln(x_{i,k}^{q}+1) EQ (8)

Using the aggregation function ƒ learned during this stage, implementations herein can calculate the aggregated performance indicator 610 for each ad-keyword pair in the historic ad data 138. For example, an ad-keyword pair typically is put into use for a period of time before sufficient historical information is collected to provide the PIs 604. Subsequently, as indicated at block 622, and as described additionally below, the aggregated performance indictors 610 may be used in the ad-metric-based learning stage 606 to learn the mapping function g.

### Learning Mapping Function g

Using the learned aggregation function ƒ implementations herein can calculate the aggregated PI 610 for each ad-keyword pair in the historic ad data 138, as described above in performance-based stage 602. The aggregated PI 610 can be used as a ground truth to learning the mapping function g in the ad metric-based stage 606. In some implementations, any general learning-to-rank methods may be applied in stage 606 to learn the mapping function g. One example of a suitable learning ranking method is RankNet, as described by Burges et al., in “Learning to Rank using Gradient Descent,” Proceedings of the 22nd International Conference on Machine Learning, Bonn, Germany, 2005. For example, RankNet is a learning ranking function based on a gradient descent that uses a neural network to model the underlying ranking function. As described by Burges et al., for the ith training sample, the outputs of a net are denoted by oᵢ, and the targets by tᵢ. Then, let the transfer function of each node in the jth layer of nodes be h^{j}, and let the cost function be Σᵢ₌₁^{q} c(oᵢtᵢ). Accordingly, if aₖ are the parameters of the model, then a gradient descent step amounts to

$${δα}_{k} = - {η}_{k} \frac{\partial c}{\partial {α}_{k}} ,$$

where the ηₖ are positive learning rates.

The net embodies the following function

oᵢ=h³(Σⱼwᵢⱼ³²h²(Σₖwⱼₖ²¹xₖ+bⱼ²)+bᵢ³)≡hᵢ³ EQ (9)

where for the weights w and offsets b, the upper indices index the node layer, and the lower indices index the nodes within each corresponding layer.

Taking derivatives of c with respect to the parameters gives

$$\begin{matrix}\frac{\partial c}{\partial {b}_{i}^{3}} = \frac{\partial c}{\partial {o}_{i}} {h}_{i}^{′3} ≡ {Δ}_{i}^{3} & EQ ( 10 ) \\ \frac{\partial c}{\partial {w}_{in}^{32}} = {Δ}_{i}^{3} {h}_{n}^{2} & EQ ( 11 ) \\ \frac{\partial c}{\partial {b}_{m}^{2}} = {h}_{m}^{′2} ( {\sum }_{i} {Δ}_{i}^{3} {w}_{im}^{32} ) ≡ {Δ}_{m}^{2} & EQ ( 12 ) \\ \frac{\partial c}{\partial {w}_{mn}^{21}} = {x}_{n} {Δ}_{m}^{2} & EQ ( 13 )\end{matrix}$$

where xₙ is the nth component of the input.

Burges et al. further describe that for a net with a single output, the above may be generalized to the ranking problem as follows. The cost function becomes a function of the difference of the outputs of two consecutive training samples: c(o₂−o₁). Here it is assumed that the first pattern is known to rank higher than, or equal to, the second (so that, in the first case, c is chosen to be monotonic increasing). Note that c can include parameters encoding the weight assigned to a given pair. A forward prop is performed for the first sample; each node's activation and gradient value are stored; a forward prop is then performed for the second sample, and the activations and gradients are again stored. The gradient of the cost is then

$$\frac{\partial c}{\partial α} = ( \frac{\partial {o}_{2}}{\partial α} - \frac{\partial {o}_{1}}{\partial α} ) {c}^{′} .$$

It is possible to use the same notation as before but add a subscript, 1 or 2, denoting which pattern is the argument of the given function, and drop the index on the last layer. Thus, denoting c′≡c′(o₂−o₁) yields the following:

$$\begin{matrix}\frac{\partial c}{\partial {b}^{3}} = {c}^{′} ( {h}_{2}^{′3} - {h}_{1}^{′3} ) ≡ {Δ}_{2}^{3} - {Δ}_{1}^{3} & EQ ( 14 ) \\ \frac{\partial c}{\partial {w}_{m}^{32}} = {Δ}_{2}^{3} {h}_{2 m}^{2} - {Δ}_{1}^{3} {h}_{1 m}^{2} & EQ ( 15 ) \\ \frac{\partial c}{\partial {b}_{m}^{2}} = {Δ}_{2}^{3} {w}_{m}^{32} {h}_{2 m}^{′2} - {Δ}_{1}^{3} {w}_{m}^{32} {h}_{1 m}^{′2} & EQ ( 16 ) \\ \frac{\partial c}{\partial {w}_{mn}^{21}} = {Δ}_{2 m}^{2} {h}_{2 n}^{1} - {Δ}_{1 m}^{2} {h}_{1 n}^{1} & EQ ( 17 )\end{matrix}$$

Note that the terms always take the form of the difference of a term depending on x₁ and a term depending on x₂, ‘coupled’ by an overall multiplicative factor of c′, which depends on both. A sum over weights does not appear because a two layer net with one output is being considered, but for more layers the sum appears as above, thus training RankNet is accomplished by a straightforward modification of back-prop.

According to some implementations, the mapping function g may be trained in a manner similar to the RankNet model described above, or other suitable trainable learning ranking function. The mapping function g may map a plurality of advertisement metrics 608 including landing page relevance 624, landing page quality 626, ad copy relevance 628, ad copy quality 630, and various other metrics related to the advertisement such as ad copy length, time required to load the landing page, relevance to a locale in which the ad will be shown, number of times a keyword occurs in the ad copy, number of times the keyword appears in the ad title, and the like. Further the mapping function g may also take into consideration a bid 632 submitted for the keyword in association with the advertisement or ad group. As mentioned above, various features may be used to determine landing page relevance 624 such as whether the landing page is directly related to the ad and the keyword, whether relevant content appears on the first page of the landing page and displays the keyword in text format, and the like. Various features for determining landing page quality may include whether the landing page adheres to certain editorial guidelines, is well organized, and easy for a user to purchase a product, sign up for a service, create an account, or the like. Further, the landing page should not include unrelated advertising, contain misleading offers, spyware, or have functionality problems. Various features for determining ad copy relevance include whether or not the ad copy includes the keyword. Various features for determining the ad copy quality include whether the ad copy has a good grammatical structure, dynamic text, unique selling points, is focused toward an identified potential customer, and includes language to motivate a user to click on the ad. Accordingly, the function g may take into consideration these and other features of the ad metrics 624-630. The function g may apply a ranking to map the ad metrics 624-630 to the aggregated performance indicator 610 for each ad-keyword pair in a set of ad-keyword pairs taken from the historic ad data 138. The mapping function g is learned by using the corresponding aggregated performance indicator 610 as a ground truth for determining which ad metrics 608 lead to higher aggregated performance indicators 610. Thus, by using aggregated performance indicators 610 and the ad metrics 608 extracted for a plurality of ad-keyword pairs, the mapping function g may be trained for mapping or associating each of the ad metrics 608 with a corresponding degree of performance.

Following training, the mapping function g may be used for determining a quality score 634 for one or more of ad-keyword pairs 636. Thus, according to some implementations, the function ƒ is used in training, and is not directly used by the advertising service for calculating quality scores. Instead, the trained mapping function g may be used by the advertising service for estimating quality scores. Given an ad-keyword pair 636 (e.g., one of the ad-keyword pairs 140, whether one that has previously been used or a new one that has no historical information), implementations herein may extract the ad metrics 608 (features) for the ad-keyword pair 636, and then use mapping function g to map the extracted ad metrics 608 to a quality score 634.

Further, the functions ƒ and g may be retrained and updated periodically. For example, some implementations may retrain the two functions ƒ and g every week, every two weeks, every month, or the like, using the latest historical ad data 138. Following retraining, the quality scores for some or all of the currently active ad-keyword pairs 140 may be recalculated based on the updated function g.

### Example Process

FIG. 7 is a flow diagram of an example process 700 for determining a quality score according to some implementations herein. For discussion purposes, the process 700 is described with reference to the system architecture 500 of FIG. 5, although other frameworks, system architectures and environments may implement this process.

At block 702, the quality score estimation component 136 trains an aggregation function using historic performance indicators of a set of ad-keyword pairs. For example, for a set of ad-keyword pairs having historic performance data, the aggregation function may apply a Kendall's tau correlation between a plurality of performance indicators and an aggregated performance indicator that represents an overall performance of an ad-keyword pair.

At block 704, the quality score estimation component 136 trains a mapping function based on ad metrics for the set of ad-keyword pairs. For example, the mapping function may be trained from the set of ad-keyword pairs using the aggregated performance indicators as a ground truth for mapping a plurality of ad metrics from each ad-keyword pair in the training data to the corresponding aggregated performance indicator determined for each ad-keyword pair.

At block 706, the quality score estimation component 136 selects an advertisement-keyword pair for determining a quality score.

At block 708, the quality score estimation component 136 extracts ad metrics from the selected ad-keyword pair.

At block 710, the quality score estimation component 136 applies the trained mapping function to map ad metrics of the selected ad-keyword pair to determine a quality score for the selected ad-keyword pair.

At block 712, the advertising component may employ the quality score in an advertising service. For example, the advertising component may utilize the quality score for various decision making processes, such as when determining whether to display the advertisement, include the advertisement in search results, where to rank the advertisement relative to other advertisements, and the like.

At block 714, the advertising component may periodically use recent historic ad data to retrain the aggregation function and/or the mapping function. For example, the aggregation function and the mapping function may be retrained one a week, once every two weeks, or the like, and the quality scores for some or all of the current ad-keyword pairs may be recalculated based on the retrained mapping function.

### Example Process for Providing Feedback

FIG. 8 is a flow diagram of an example process 800 for providing an advertiser with feedback regarding a quality score according to some implementations herein. For discussion purposes, the process 800 is described with reference to the system architecture 500 of FIG. 5, although other frameworks, system architectures and environments may implement this process.

At block 802, the search service component receives an advertisement-keyword pair from an advertiser.

At block 804, the quality score estimation component 136 determines a quality score for the advertisement-keyword pair based, at least in part, on one or more ad metrics determined for the ad-keyword pair. For example, the quality score estimation component 136 may determine the quality score upon receipt of the advertisement by applying the mapping function g to the ad metrics for the ad-keyword pair.

At block 806, the feedback component 142 provides the estimated quality score to the advertiser.

At block 808, the feedback component 142 may also provide information to the advertiser indicating one or more ad metrics as the reason for the quality score, suggest improvements to one or more ad metrics, or the like.

### Example Computing Device

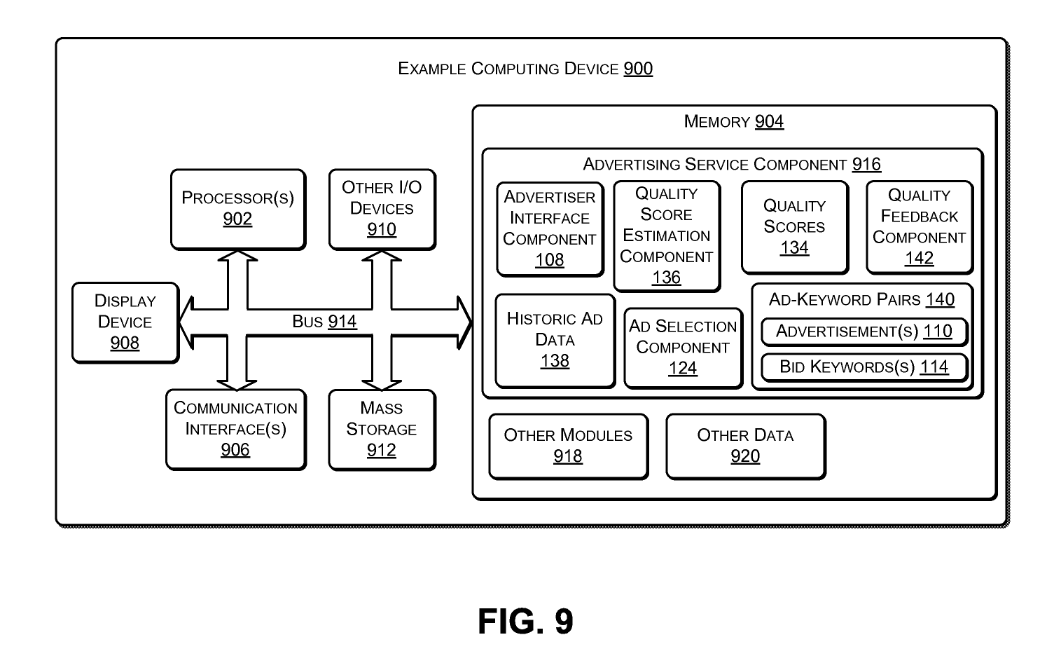

FIG. 9 illustrates an example configuration of a computing device 900 that can be used to implement the components and functions of the quality score estimation described herein, such as for implementing the quality score estimation component 136 described with reference to the advertising service 102 of FIG. 1 and/or the advertising service component 506 of FIG. 5. The computing device 900 may include at least one processor 902, a memory 904, communication interfaces 906, a display device 908, other input/output (I/O) devices 910, and one or more mass storage devices 912, able to communicate with each other, such as through a system bus 914 or other suitable connection.

The processor 902 may be a single processing unit or a number of processing units, all of which may include single or multiple computing units or multiple cores. The processor 902 can be implemented as one or more microprocessors, microcomputers, microcontrollers, digital signal processors, central processing units, state machines, logic circuitries, and/or any devices that manipulate signals based on operational instructions. Among other capabilities, the processor 902 can be configured to fetch and execute computer-readable instructions or processor-accessible instructions stored in the memory 904, mass storage devices 912, or other computer-readable storage media.

The computing device 900 may also include one or more communication interfaces 906 for exchanging data with other devices, such as via a network, direct connection, or the like, as discussed above. The communication interfaces 906 can facilitate communications within a wide variety of networks and protocol types, including wired networks (e.g., LAN, cable, etc.) and wireless networks (e.g., WLAN, cellular, satellite, etc.), the Internet and the like. Communication interfaces 906 can also provide communication with external storage (not shown), such as in a storage array, network attached storage, storage area network, or the like.

A display device 908, such as a monitor may be included in some implementations for displaying information to users. Other I/O devices 910 may be devices that receive various inputs from a user and provide various outputs to the user, and can include a keyboard, a remote controller, a mouse, a printer, audio input/output devices, and so forth.

Memory 904 and mass storage devices 912 are examples of computer-readable media for storing instructions which are executed by the processor 902 to perform the various functions described above. For example, memory 904 may generally include both volatile memory and non-volatile memory (e.g., RAM, ROM, or the like). Further, mass storage devices 912 may generally include hard disk drives, solid-state drives, removable media, including external and removable drives, memory cards, Flash memory, floppy disks, optical disks (e.g., CD, DVD), a storage array, a network attached storage, a storage area network, or the like. Both memory 904 and mass storage devices 912 may be non-transitory computer storage media, and may collectively be referred to as memory or computer-readable media herein.

Memory 904 and/or mass storage 912 are capable of storing computer-readable, processor-executable instructions as computer program code that can be executed by the processor 902 as a particular machine configured for carrying out the operations and functions described in the implementations herein. For example, memory 904 may include modules and components for determining and applying quality scores according to the implementations herein. In the illustrated example, memory 904 includes an advertising service component 916 that affords functionality for quality score estimation. For example, advertising service component 916 may include advertiser interface component 108, ad selection component 124, quality scores 134, quality score estimation component 136, historic ad data 138, ad keyword pairs 140, and quality feedback component 142. As described above, quality score estimation component 136 may determine quality scores 134 for ad-keyword pairs 140 using a multistage machine learning approach. Memory 904 may also include one or more other modules 918, such as the auction component 508, the history component 510, and components of the search system 116, such as the query response component 516. Other modules 918 may also include an operating system, drivers, communication software, or the like. Memory 904 may also include other data 920 to carry out the functions described above. Further, while the quality score estimation component 136 has been illustrated and described herein in the environment of an advertising service, other implementations of the quality score estimation component 136 are not limited to use with an advertising service.

Although illustrated in FIG. 9 as being stored in memory 904 of computing device 900, advertising service component 916, or portions thereof, may be implemented using any form of computer-readable media that is accessible by computing device 900. Computer-readable media includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
under control of one or more processors configured with executable instructions,
generating a mapping function based on advertisement metrics and historic performance of a plurality of ad-keyword pairs;
selecting a particular ad-keyword pair for determining a quality score;
determining one or more advertisement metrics for the particular ad-keyword pair;
applying the mapping function to map the one or more advertisement metrics of the particular ad-keyword pair to determine the quality score; and
utilizing the quality score in an advertisement service.

2. The method as recited in claim 1, further comprising generating the mapping function by applying a learned aggregation function for aggregating historic performance indicators to determine aggregated performance indictors representing the historic performance for the plurality of ad-keyword pairs, wherein the aggregation function is learned by maximizing a Kendall's tau correlation between the aggregated performance indicators and the one or more historic performance indicators.

3. The method as recited in claim 2, wherein the learned aggregation function is based at least in part on a multi-dimensional vector having a number of dimensions corresponding to a number of the historic performance indicators utilized.

4. The method as recited in claim 2, further comprising training the aggregation function, the training comprising:
obtaining a set of training data including the historic performance indicators for the plurality of ad-keyword pairs;
applying normalization to normalize the performance indicators;
counting a pair number for each keyword;
initializing an aggregation parameter; and
updating the aggregation parameter using the historic performance of the plurality of ad-keyword pairs.

5. The method as recited in claim 1, wherein the historic performance for the plurality of ad-keyword pairs includes performance indicators comprising at least one of:
a number of impressions of the ad-keyword pair;
a number of clicks on the ad-keyword pair;
a click-through rate for the ad-keyword pair;
a cost per click for the ad-keyword pair; or
a total cost for the ad-keyword pair.

6. The method as recited in claim 1, wherein the mapping function is learned according to a learning ranking function that maps advertisement metrics of an ad-keyword pair of the plurality of ad-keyword pairs to a corresponding aggregated performance indicator.

7. The method as recited in claim 1, wherein the advertisement metrics of the ad-keyword pair comprise at least one of:
landing page relevance;
landing page quality;
ad copy relevance;
ad copy quality; or
ad copy length.

8. The method as recited in claim 1, further comprising providing the quality score as feedback to an advertiser that is a source of the ad-keyword pair.

9. The method as recited in claim 8, further comprising providing information to the advertiser for improving the quality score based at least in part on the advertisement metrics determined for the ad-keyword pair.

10. A computing device comprising:
one or more processors in operable communication with computer-readable media;
a quality score estimation component, maintained on the computer-readable media and executed on the one or more processors, to perform operations comprising:
training an aggregation function using historic performance indicators of a set of ad-keyword pairs;
training a mapping function using aggregated performance indicators determined for the set of ad-keyword pairs and advertisement metrics extracted from the set of ad-keyword pairs;
selecting a particular ad-keyword pair for determining a quality score;
extracting one or more of the advertisement metrics from the particular ad-keyword pair;
applying the trained mapping function to the one or more extracted advertisement metrics of the particular ad-keyword pair for determining the quality score for the particular ad-keyword pair; and
employing the quality score when determining whether to display an advertisement associated with the particular ad-keyword pair.

11. The computing device as recited in claim 10, wherein the training the mapping function is based, at least in part, on a ranking correlation of the advertisement metrics for the set of ad-keyword pairs using corresponding aggregated performance indicators as a ground truth.

12. The computing device as recited in claim 11, the operations further comprising:
periodically retraining at least one of the mapping function or the aggregation function using recent historic data for a set of ad-keyword pairs; and
recalculating one or more previously-calculated quality scores for one or more ad-keyword pairs.

13. The computing device as recited in claim 10, wherein the advertisement metrics comprise at least one of:
landing page relevance;
landing page quality;
ad copy relevance;
ad copy quality; or
ad copy length.

14. The computing device as recited in claim 10, wherein the historic performance indicators for the set of ad-keyword pairs comprise at least one of:
a number of impressions of the ad-keyword pair;
a number of clicks on the ad-keyword pair;
a click-through rate for the ad-keyword pair;
a cost per click for the ad-keyword pair; or
a total cost for the ad-keyword pair.

15. The computing device as recited in claim 10, wherein the aggregation function is trained by maximizing a Kendall's tau correlation between the aggregated performance indicators and the historic performance indicators.

16. One or more computer-readable media having instructions stored thereon executable by a processor to perform operations comprising:
training a mapping function based at least in part on advertisement metrics for a set of ad-keyword pairs, the mapping function being trained as a ranking function;
selecting an ad-keyword pair for determining a quality score;
applying the trained mapping function to map advertisement metrics of the selected ad-keyword pair to determine at least in part a quality score; and
utilizing the quality score in an advertisement service.

17. The one or more computer-readable media as recited in claim 16, the operations further comprising training an aggregation function using historic performance indicators of the set of ad-keyword pairs.

18. The one or more computer-readable media as recited in claim 17, the operations further comprising:
applying the trained aggregation function to a set of ad-keyword pairs to determine aggregated performance indicators;
training the mapping function by mapping the advertisement metrics of the set of ad-keyword pairs to corresponding aggregated performance indicators.

19. The one or more computer-readable media as recited in claim 16, the operations further comprising providing the quality score as feedback to an advertiser that is a source of the advertisement.

20. The one or more computer-readable media as recited in claim 16, wherein the advertisement metrics comprise at least one of:
landing page relevance;
landing page quality;
ad copy relevance;
ad copy quality; or
ad copy length.
